(19) United States
(12) Patent Application Publication
(10) Pub. No.: US 2019/0153178 A1
(43) Pub. Date: May 23, 2019

(54) METHOD FOR PRODUCING PARTS MADE OF A COMPOSITE MATERIAL WITH REINFORCERS

(71) Applicant: ARKEMA FRANCE, Colombes (FR)

(72) Inventors: Gilles HOCHSTETTER, l?Hay Les Roses (FR); Mathieu CAPELOT, Bernay (FR)

(73) Assignee: ARKEMA FRANCE, Colombes (FR)

(21) Appl. No.: 16/091,256

(22) PCT Filed: Mar. 31, 2017
(86) PCT No.: PCT/FR2017/050740

§ 371 Date: Oct. 4, 2018

(30) Foreign Application Priority Data
Apr. 5, 2016 (FR) FR1652951

(51) Int. Cl. C08J 5/24; C08J 5/04; B29C 70/06

(52) U.S. Cl. CPC C08J 5/24; C08J 5/047; B29C 70/06; C08J 2377/00; B29K 2709/08; C08J 2333/12; C08J 2433/12; C08J 2363/00; C08J 2477/00

(57) ABSTRACT

A method of manufacturing a component made of composite material whereby the said component is obtained from a preform containing local reinforcers and a first resin of low viscosity. The method includes: creation of the said preform comprising a first fibrous material and the said local reinforcers being in the form of reinforcers formed of a second fibrous material having fibres of mechanical strength greater than that of the fibres of the first fibrous material, so that they exhibit an elastic modulus or breaking stress at least 30% higher than that of the fibres of the said first fibrous material, the said second fibrous material being pre-impregnated with a thermoplastic, acrylic or polyamide polymer second resin having a glass transition temperature (Tg) above 80° C., the amount of polymer second resin being comprised between 25% and 60% by volume with respect to the total volume of the said second fibrous material.

### TECHNICAL FIELD OF THE INVENTION

The invention relates to the field of composite materials for the manufacture of two- or three-dimensional parts.

The invention more particularly relates to a process for the manufacture of parts made of composite material by impregnation of a fibrous substrate, hereinafter denoted preform, by means of a weakly viscous polymer resin, followed by a molding operation, and also to the parts made of composite materials obtained by the implementation of such a process.

### PRIOR ART

A composite material is an assembly of at least two immiscible components. A synergistic effect is obtained by such an assembly, so that the composite material obtained has in particular mechanical and/or thermal properties which each of the initial components does not have or does have but to a lesser degree in comparison with the composite material.

Moreover, a composite material comprises at least one reinforcing material consisting of woven or nonwoven fibers which confers good mechanical properties on said composite material, in particular good resistance to the mechanical stresses experienced by the composite material, and by a matrix material, or more simply matrix, which forms a continuous phase and which provides said composite material with its cohesion. Among the different types of composites used in industry, composites having an organic matrix are the most widely represented. In the case of composites having an organic matrix, the matrix material is generally a polymer. This polymer can either be a thermosetting polymer or a thermoplastic polymer.

For certain applications, the preparation of the composite material is carried out first by the manufacture of a “preform”. A preform generally consists of a plurality of prepreg layers. The prepregs are themselves composite materials comprising a woven or nonwoven fibrous material, for example consisting of carbon fibers or of glass fibers, and a polymer matrix consisting of a polymer resin.

According to a process of RTM (Resin Transfert Molding) or C-RTM (Compression Resin Transfert Molding) type, the preform is placed in a closed mold and subsequently impregnated with a weakly viscous resin then injected into said closed mold. This resin is preferably polymerized in situ, after the phase of impregnation of the preform, in order to thoroughly impregnate the preform. In the case of C-RTM, the resin is injected over the surface of the preform and the final compression of the mold forces the full impregnation of the preform by the resin. During the injection and the compression, the mold is closed and airtight and even often placed under vacuum in order to promote the impregnation of the fibers.

Compression by the wet route (LCM, “liquid compression molding”, or WCM, “wet compression molding”, or DFCM, “dynamic fluid compression molding”) uses the same type of preform but differs from C-RTM in that the resin is deposited directly open mold, on the preform already positioned in the mold, which mold is preferably heated beforehand. The mold is subsequently closed, which, as in the case of C-RTM, forces the full impregnation of the preform by the resin. This phase is followed by an in situ polymerization of the resin.

In these different processes, the preform is an intermediate material, the shape of which corresponds to that of the final composite part.

In another version, the compression by the wet route (LCM or WCM or DFCM) uses a flat preform composed of an assembly of flat semifinished products partially preimpregnated with resin and which will be shaped during the final operation of manufacture of the composite part. The preimpregnation of the preform to the final content of resin then takes place outside the mold with a liquid resin. This preimpregnation is followed by a transfer of the preimpregnated preform into the preheated mold, making possible shaping by compression during the closing of the hot mold (otherwise known as hot stamping operation), which will be followed by an in situ polymerization.

When the not completely polymerized resin is injected into the closed mold, reference will be made, for simplicity, to closed-mold process.

When the not completely polymerized resin is deposited on the preform outside the mold or open mold, reference will be made, for simplicity, to open-mold process.

The parts made of composite materials which are obtained by the implementation of these processes have to have good mechanical properties, such as mechanical strength, and thermal resistance.

Depending on the fields of application, it is sometimes necessary to use cheap composite parts. Although less expensive, these parts have all the same to satisfy a strict specification and to have satisfactory mechanical properties for the applications in question.

To this end, the preform necessary for the manufacture of the composite parts can, for example, be locally reinforced. This reinforcing can be carried out by locally creating a stiffener by deformation of the preform. However, the geometry of the preform then becomes complex, which constitutes a source of technical difficulty and an additional cost for its manufacture. Furthermore, a high deformability of the fibrous material of the preform is necessary, with limits the choice of the type of fibrous material. This geometrical complexity is also an obstacle with regard to the quality of impregnation in infusion, RTM, VARTM, C-RTM or LCM or WCM or DFCM process, in particular as regards the walls of the preform, which are no longer perpendicular to the axis of compression, during the phase of compression during the closing of the mold.

Furthermore, the solution of the stiffener by deformation of the preform, among other solutions, generally does not make it possible to guarantee optimal mechanical properties of the composite part throughout its operational temperature range, in particular when the operational temperature of the composite part is greater than the glass transition temperature (Tg) of the impregnation resin subsequently used to impregnate the preform and to obtain the composite part.

Finally, the solution of the stiffener by deformation of the preform, among other solutions, generally does not make possible the passage through cataphoresis (this is a technique for deposition by electrophoresis of industrial paint) of the composite part obtained for amorphous thermoplastic resins having a glass transition temperature (Tg) which is lower than the temperatures of the cycle of the cataphoresis or for semicrystalline resins having a lower melting point (M.p.) than the temperatures of the cycle of the cataphoresis, which can result in a decompaction of the composite. As regards thermosetting resins, if their Tg is lower than the temperatures of the cycle of the cataphoresis, a deformation of the final composite part may be observed after the cataphoresis cycle.

### TECHNICAL PROBLEM

It is thus an aim of the invention to overcome the disadvantages of the prior art by providing a process for the manufacture of a part made of composite material starting from a preform, said process providing an alternative to the existing solutions for the local reinforcing of the preform and of the composite part obtained from this preform.

The process also makes it possible to guarantee good mechanical properties of the composite part obtained by said process throughout the operational temperature range of the composite part and in particular for operational temperatures greater than the glass transition temperature (Tg) of the resin for impregnation of the preform.

The process additionally makes possible the passage through cataphoresis of the composite part, whatever the cycle temperatures used in cataphoresis, this being the case for any type of resin for impregnation of the preform, in particular for impregnation resins having a glass transition temperature (Tg) or, in the case of a semicrystalline resin, a melting point (M.p.) which is lower than the temperatures at which the cataphoresis is carried out and which is thus not compatible with the cataphoresis, or for which the passage through cataphoresis of a composite part impregnated with this resin generally results in reduced mechanical properties or in a deformation of said part.

The glass transition temperature Tg will subsequently be denoted Tg for simplicity.

The melting point M.p. will subsequently be denoted M.p. for simplicity.

### BRIEF DESCRIPTION OF THE INVENTION

To this end, a subject matter of the invention is a process for the manufacture of a part made of composite material, characterized in that said part is obtained from a preform comprising local reinforcers and a first impregnation resin of low viscosity, of less than 100 Pa·s, for said preform and in that said process comprises the following stages:
i) production of said preform comprising a first fibrous material and said local reinforcers, which are provided in the form of reinforcers formed of a second fibrous material having fibers with a greater mechanical strength than that of the fibers of the first fibrous material, so that they exhibit a modulus of rupture or a breaking stress greater by at least 30% than that of the fibers of said first fibrous material, said second fibrous material being preimpregnated with a second, acrylic or polyamide, thermoplastic polymer resin having a glass transition temperature (Tg) of greater than 80° C., the amount of second polymer resin being between 25% and 60% by volume, with respect to the total volume of said second fibrous material,
ii) impregnation of said preform with the first impregnation resin,
iii) cooling of said impregnated preform in order to obtain the part.

The use of a second thermoplastic polymer resin, the glass transition temperature (Tg) of which is greater than 80° C., makes it possible to enhance the mechanical and/or thermal performance qualities of the reinforcing strips and consequently of the part produced.

According to other optional characteristics of the process:
the part is made by injection molding the resin in a closed mold or by deposition of the resin on the preform either outside the mold or in the open mold containing the preform;
the local reinforcers are provided either in the form of felts or of mats, or in the form of woven fabrics, of nonwoven fabrics (NCF, “Non Crimp Fabrics”), of unidirectional fibers or of braids, and they preferably consist of continuous fibers and are provided in the form of webs or of strips of woven fabrics, of nonwoven fabrics, of unidirectional (UD) fibers or of braids;
stage i) of production of said preform comprises the deposition of said local reinforcers at the surface of said preform and/or the insertion of said local reinforcers into the preform;
   by stacking layers of woven fabrics of fibers or layers of nonwoven fibers (NCF, “Non Crimp Fabrics”) or layers of mats of fibers, said fibers being either dry or weakly preimpregnated with a third resin, optionally different from the first and from the second resin, and by then depositing at the surface the reinforcers formed of the second fibrous material in order to produce said local reinforcers, or
   by manufacturing the preform from unidirectional strips weakly preimpregnated with a third resin optionally different from the first and the second resin, which are deposited by means of a robot, and by adding, in the same operation and preferably at the core of the preform, the reinforcers formed of the second completely preimpregnated fibrous material which constitute said local reinforcers;
stage i) of production of the preform is carried out by an automatic fiber placement (AFP) process in which said reinforcers are deposited at the surface of the preform and/or inserted into the preform during its manufacture, by a servo robot;
the reinforcing fibers constituting the webs, woven fabrics, NCFs, mats of fibers or unidirectional strips can be comixed with one or more polymer fibers;
the polymer or polymers constituting the fibers comixed with the reinforcing fibers are ductile within the operational temperature range of the composite;
the polymer or polymers constituting the fibers comixed with the reinforcing fibers comprise electrically and/or thermally conducting fillers which are preferably carbon nanotubes;
the preform is shaped by a hot stamping process comprising a first stage of preheating the preform followed by a second stage of stamping to the final shape, by means of a heating platen press;
the process is an infusion molding process, preferably used for the manufacture of wind turbine parts;
the process is a resin transfer molding (RTM), compression resin transfer molding (C-RTM) or vacuum assisted resin transfer molding (VARTM) process;
the process is a process for compression molding by the wet route (LCM or WCM or DFCM);
in the case of processes in a closed mold, the first impregnation resin is injected at a pressure of between 500 mbar and 200 bar, preferably of between 800 mbar and 100 bar and more preferably of between 800 mbar and 60 bar;
in the case of a process in a closed mold, the first impregnation resin exhibits, at the injection temperature, a viscosity of less than 100 Pa·s, preferably of less than 20 Pa·s and more preferred again of less than 0.2 Pa·s;
in the case of a process in an open mold, the first impregnation resin exhibits, at the molding temperature, a viscosity of less than 100 Pa·s, preferably of less than 20 Pa·s and more preferred again of less than 0.2 Pa·s;
the first fibrous material is made of glass fibers;
the first fibrous material is preimpregnated with a third polymer resin;
the second reinforcing fibrous material is made of carbon fibers;
the first fibrous material is made of glass fibers and the second reinforcing fibrous material is made of carbon fibers;
the second polymer resin impregnating the second fibrous material is chosen from amorphous thermoplastic resins having a Tg of greater than or equal to 80° C., preferably of greater than or equal to 180° C. and more preferably of greater than or equal to 230° C., and preferably of less than 250° C.;
the second polymer resin impregnating the second fibrous material is chosen from semicrystalline thermoplastic resins exhibiting a Tg of greater than or equal to 80° C., preferably of greater than or equal to 120° C. and more preferably of greater than or equal to 150° C., and a M.p. of greater than or equal to 180° C., preferably of greater than or equal to 200° C. and more preferably of greater than or equal to 230° C. and of less than 420° C., preferably of less than 390° C. and more preferably of less than 300° C.;
the second polymer resin impregnating the second fibrous material is a thermoplastic resin chosen from: polyamides (PA), in particular aromatic or semiaromatic polyamides, including copolyamides, which are semicrystalline or amorphous, more particularly high temperature semicrystalline polyamides (HTPA), or also acrylic thermoplastic resins, such as poly(methyl methacrylate) (PMMA) or methyl methacrylate (MMA) copolymers, or their blends;
the second polymer resin impregnating the second fibrous material is a semicrystalline resin selected from polyamides (PA), in particular aromatic or semiaromatic polyamides, including copolyamides, preferably a high temperature semicrystalline polyamide (HTPA) preferably chosen from a polyamide x.T or a copolyamide x.T/x′.T, in which T is terephthalic acid and x is a linear C₉ to C₁₈, preferably C₉ to C₁₂, aliphatic diamine and x′ is a different diamine from x, so that the molar ratio [x/(x+x′)] is between 15% and 45%, limits included, x′ being chosen from a diamine monobranched by a methyl or an ethyl and having a difference in chain length of at least one carbon atom from the diamine x, or from xylylenediamine or a linear C₄ to C₁₈ aliphatic diamine in the case where x is C₁₀ to C₁₈, or x′ C₉ to C₁₈ in the case where x is C₉ or C₁₀;
the second fibrous material of the local reinforcer comprises an amount of second polymer resin of between 25% and 60% by volume, preferably between 35% and 60%, more preferably between 35% and 55% and even more preferably between 35% and 50%, by volume, with respect to the total volume of said second fibrous material;
the first impregnation resin has a Tg of less than 230° C., preferably of less than or equal to 150° C. and more particularly of less than or equal to 120° C., and more preferably still of less than or equal to 100° C.;
the first impregnation resin is semicrystalline and has a M.p. of less than 230° C., preferably of less than or equal to 200° C. and more preferably still of less than or equal to 190° C.;
the first impregnation resin is chosen from: thermosetting resins, preferably polyester, vinyl ester, acrylic or epoxy (epoxy-amine) resins, polyimide thermosetting resins, in particular bismaleimide resin, or polyurethane thermosetting resins, or from thermoplastic resins, preferably polyamide (PA, HTPA) resins, acrylic resins or their blend;
the first impregnation resin is chosen from epoxy resins and the second polymer resin for impregnation of the second fibrous material of the local reinforcer is a polyamide (PA, HTPA) resin;
the first resin for impregnation of the preform is compatible with said second for impregnation of the second fibrous material and/or with the third resin for impregnation of the first fibrous material.

The invention additionally relates to a part made of composite material, mainly characterized in that it comprises a preform impregnated with a first impregnation resin, said preform comprising a first fibrous material and local reinforcers formed of a second fibrous material having fibers with a greater strength than that of the fibers of the first fibrous material, and exhibiting a modulus greater by at least 30% and preferably greater by at least 100% than that of the fibers of said first fibrous material, said second fibrous material being preimpregnated with a second, acrylic or polyamide, thermoplastic polymer resin having a glass transition temperature (Tg) of greater than 80° C., the amount of second polymer resin being between 25% and 60% by volume, with respect to the total volume of said second fibrous material, said preform being impregnated with said first impregnation resin.

Advantageously, the composite part is obtained by a process as defined above.

The first fibrous material is preimpregnated with a third polymer resin.

Preferably, the part comprises:
at least one preform comprising a first fibrous material made of glass fibers and optionally preimpregnated with a polymer resin,
at least one reinforcer comprising a second fibrous material made of carbon fibers, said second fibrous material being preimpregnated with a thermoplastic polymer resin having a glass transition temperature (Tg) of greater than 80° C., preferably a polyamide (PA, HTPA) resin,
a resin for impregnation of said preform, with a low viscosity, of less than 100 Pa·s, chosen from epoxy resins, polyamide (PA, HTPA) resins or acrylic resins.

Alternatively, the polymer resin of the reinforcer comprising the second fibrous material is chosen from acrylic thermoplastic resins, such as poly(methyl methacrylate) (PMMA) or methyl methacrylate (MMA) copolymers.

Such a part is used in particular for building engines or machines, aircraft or ships, or water sports, the motor vehicle industry, in particular for motor vehicle chassis, wind, tidal or hydroelectric power (wind turbine, marine turbine, turbines) or in the construction industry, or also for the health and medical fields, the army and the armaments industry, sports and leisure, the electronics industry, or solar (mirrors) or photovoltaic (panels) power plants.

### DETAILED DESCRIPTION OF THE INVENTION

A first subject matter of the invention relates to a process for the manufacture of parts made of composite material, in particular structured or semistructured three-dimensional parts. The manufacturing process comprises a stage of production of a preform comprising a first composite material, also subsequently denoted as “prepreg”, said prepreg comprising a first fibrous material a1) and a polymer matrix a2) impregnating the fibrous material. The preform also comprises local reinforcers b) which are provided in the form of reinforcers formed from a second fibrous material b1) impregnated with a polymer matrix b2). These reinforcers are deposited on the preform or inserted into said preform, preferably at the corresponding points of the final composite part liable to be subjected to the greatest mechanical stresses and strains.

The final composite part is obtained by placing the preform, comprising the local reinforcers, in a mold, then impregnation of said preform by injection of a resin of low viscosity into the closed mold, optionally followed by a phase of compression (case of C-RTM).

In the case of compression molding by the wet route (LCM, WCM, DFCM), the final composite part is obtained by placing the preform, comprising the local reinforcers, in a mold, the impregnation of the preform having been carried out by deposition of a resin of low viscosity on the fibrous preform, either outside the mold or in the open mold, and is followed by a phase of compression during the closing of the mold.

“Resin of low viscosity” is understood to mean a resin, the viscosity of which, measured using a plate-plate rheometer, at the temperature of introduction of the resin into the mold, and at low gradient (shear rate of less than 1 s⁻¹), is less than 100 Pa·s. Preferably, the viscosity is less than 20 Pa·s and more preferably still it is less than 0.2 Pa·s.

The term “injection” should be understood here within the broad sense and refers to manufacturing processes chosen from resin transfer molding (RTM), compression resin transfer molding (C-RTM), vacuum assisted resin transfer molding (VARTM), infusion molding, for example.

The deposition of resin on the preform, outside the mold or in the open mold, refers to processes for deposition by spray, or by flame-spray in the case of a thermoplastic resin powder, or by melting of a thermoplastic resin of low viscosity, for example by means of a melter or of an extruder, and depositions by gravity without a system of leaktight connection to the mold.

The local reinforcers are provided either in the form of mats or felts, or in the form of woven fabrics, of nonwoven fabrics, of unidirectional (UD) fibers or of braids. They preferably consist of continuous fibers and are provided in the form of webs or strips of woven fabrics, nonwoven fabrics (also denoted NCF for “Non Crimp Fabrics”), unidirectional fibers or braids.

The term “strip” is understood to mean a sheet material which exhibits a length much greater than its width. Preferably, the strips used in the context of the invention have a substantially constant width over the whole of their length. The constituent fibers of the reinforcing strip extend along a direction parallel to the length of the said reinforcing strip, which is then referred to as “unidirectional” reinforcer.

The terms “thermoplastic polymer” or “thermoplastic resin”, as used, relate to a polymer or to a resin which is not crosslinked and which can be in the molten state and more or less viscous (depending on the temperature) when it is heated to a temperature greater than its glass transition temperature Tg (amorphous polymer) or its melting point M.p. (semicrystalline polymer).

The terms “thermosetting polymer” or “thermosetting resin”, or also “crosslinkable polymer or resin”, as used, relate to a prepolymer or to a resin or to a multicomponent reactive system which is converted irreversibly into an infusible and insoluble (crosslinked) polymer network by curing (crosslinking).

The term “polymer”, as used, denotes a material comprising a sequence of one or more identical or different repeat units.

Reference will be made to “resin” or to “polymer resin” to denote a polymer or a blend of polymers and additives, such as catalysts, polymerization initiators, curing agent, and the like, for the impregnation of a fibrous substrate, such as a fibrous material in the form of rovings, of webs or also of woven fabrics, for example, or else of a preform consisting of several layers of pre-impregnated fibrous materials, known as “prepregs”. A polymer resin constitutes the polymer matrix of a composite material, such as a prepreg or a preform.

The glass transition temperatures Tg and melting points M.p. of the different polymer matrices used are measured by DSC, respectively according to the standards ISO-11357-2 and 11357-3, in second heating with a rise in temperature of 20° C./min. The temperatures are measured with an accuracy of ±1° C.

### The Prepreg of the Preform a)

As regards the first fibrous material a1) of the prepreg, it comprises fibers, in particular fibers of mineral, organic or plant origin. Mention may be made, among the fibers of mineral origin, of carbon fibers, glass fibers, basalt fibers, silica fibers or silicon carbide fibers, for example. Mention may be made, among the fibers of organic origin, of fibers based on a thermoplastic or thermosetting polymer, such as aromatic polyamide fibers, aramid fibers or polyolefin fibers, for example. Preferably, they are based on thermoplastic polymer. When they are based on an amorphous thermoplastic polymer, they exhibit a glass transition temperature Tg which will either be greater than the Tg(s) of the polymer (or blend of polymers) of the resin a2) of low viscosity used to impregnate said first fibrous material a1), when this polymer (or blend of polymers) is amorphous or thermosetting, or will be greater than the melting point(s) M.p. of the polymer (or blend of polymers) of the resin a2) of low viscosity used to impregnate said first fibrous material a1), when this polymer (or blend of polymers) is semicrystalline. When the fibers a1) are made of semicrystalline thermoplastic polymer, their melting point M.p. will be greater than the glass transition temperature(s) or melting point(s) of the polymer (or blend of polymers) of the resin a2) according to whether it (they) is (are) amorphous, thermosetting or semicrystalline. Thus, there is no risk of melting for the constituent organic fibers of the fibrous material. Mention may be made, among the fibers of plant origin, of natural fibers based on flax, hemp, silk, in particular spider silk, sisal and other cellulose fibers, in particular viscose fibers.

The fibers of the first fibrous material a1) can be used alone or as mixtures. Thus, organic fibers can be mixed with mineral fibers, in the polymeric matrix a2) of the prepreg.

The fibers are, according to preference, single-strand, multistrand or a mixture of the two, and can have several weights per unit area. In addition, they can exhibit several geometries. Thus, they can be provided in the form of cut fibers, which then make up felts or nonwoven fabrics which can be provided in the form of bands, webs, braids, rovings or pieces, or in the form of continuous fibers, which make up woven fabrics which are multidirectional (2D, 3D), braids or rovings of unidirectional (UD) fibers or nonwoven fabrics. The fibers of the fibrous material can in addition be provided in the form of a mixture of these reinforcing fibers of different geometries. Preferably, the fibers are continuous.

Preferably, the first fibrous material a1) consists of continuous fibers of carbon, of glass or of silicon carbide or their mixture, and more preferably of glass fibers. It is advantageously used in the form of a roving or of several rovings assembled together.

According to a preferred form of the invention, the fibers are glass fibers.

As regards the polymer matrix a2) of the prepreg, it advantageously consists of a thermoplastic resin.

More particularly, the thermoplastic resins participating in the structure of the polymer matrix a2) of the prepreg of the preform can be chosen from:
resins of the family of the polyamides (PA), such as polyamide 6 (PA-6), polyamide 11 (PA-11), polyamide 12 (PA-12), polyamide 6.6 (PA-6.6), polyamide 4.6 (PA-4.6), polyamide 6.10 (PA-6.10), polyamide 6.12 (PA-6.12), polyamides containing aromatic units optionally modified by urea units, in particular polyphthalamides and aramid, and block copolymers, in particular polyamide/polyether block copolymers,
polyureas, in particular aromatic polyureas,
polymers and copolymers of the family of the acrylics, such as polyacrylates, and more particularly polymethyl methacrylate (PMMA) or its derivatives,
polymers and copolymers of the family of the polyaryl ether ketones (PAEK), such as polyether ether ketone (PEEK), or the polyaryl ether ketone ketones (PAEKK), such as polyether ketone ketone (PEKK), or their derivatives,
aromatic polyetherimides (PEI),
polyaryl sulfides, in particular polyphenylene sulfides (PPS),
polyaryl sulfones, in particular polyphenylene sulfones (PPSU),
polyolefins, in particular polyethylene (PE),
polylactic acid (PLA),
polyvinyl alcohol (PVA),
fluororesins, in particular polyvinylidene fluoride (PVDF) or polytetrafluoroethylene (PTFE) or polychlorotrifluoroethylene (PCTFE),
a mixture of the abovementioned resins.

For the fluororesins, it is preferable to use a homopolymer of vinylidene fluoride (VDF of formula CH₂═CF₂) or a copolymer of VDF comprising, by weight, at least 50% by weight of VDF and at least one other monomer copolymerizable with VDF. The content of VDF is preferably greater than 80% by weight and more preferably greater than 90% by weight, in order to provide the final composite part with good mechanical strength, especially when it is subjected to thermal stresses. The comonomer can be a fluoromonomer chosen, for example, from vinyl fluoride.

Optionally, the thermoplastic resin additionally comprises carbon-based fillers, in particular carbon black, or carbon-based nanofillers, preferably chosen from carbon-based nanofillers, in particular graphenes and/or carbon nanotubes and/or carbon nanofibrils, or their mixtures. These fillers make it possible to conduct electricity and heat, and consequently make it possible to improve the fluidizing of the polymer matrix when it is heated.

According to another alternative form, the thermoplastic resin can additionally comprise additives, such as liquid crystal polymers or cyclic polybutylene terephthalate, or mixtures of these two additives, such as the CBT 100 resin marketed by Cyclics Corporation. These additives make it possible in particular to fluidize the polymer matrix in the molten state, for better penetration to the core of the fibers. Depending on the nature of the thermoplastic polymer or blend of thermoplastic polymers constituting the matrix of the prepreg, in particular its melting point, one or other of these additives will be chosen.

The constituent prepreg of the preform is preferably “dry”, in that it comprises porosities between the fibers and a small amount of polymer matrix which covers the fibers at the surface in order to hold them together. The porosities make it possible to facilitate the subsequent transportation of the impregnation resin c) within the prepreg, during the injection of said resin into a mold to form the final composite part, in order to improve the mechanical properties of the composite part and in particular its mechanical cohesion.

Thus, the percentage of polymer matrix a2) of the prepreg is advantageously between 0.2% and 15% by volume, preferably between 0.2% and 10% by volume and more preferably between 0.2% and 5% by volume, with respect to the total volume of the prepreg. In this case, reference may also be made to binder or polymer veil, having a low weight per unit area, deposited on the fibrous material in order to hold the fibers to one another.

### The Local Reinforcers b) of the Preform a)

The local reinforcers are provided either in the form of felts or mats, or in the form of woven fabrics, of nonwoven fabrics, of unidirectional fibers or of braids. They preferably consist of continuous fibers and are provided in the form of webs or strips of woven fabrics, of nonwoven fabrics, of unidirectional (UD) fibers or of braids.

Advantageously, the reinforcing fibers, constituting the webs, the woven fabrics, the layers of nonwoven fibers NCF (“Non Crimp Fabrics”), the mats of fibers or the unidirectional strips are comixed with one or more polymer fibers. The polymer or polymers constituting the fibers comixed with the reinforcing fibers are ductile within the operational temperature range of the composite. According to another manufacturing method, this of these polymers can comprise electrically and/or thermally conducting fillers, which are preferably carbon nanotubes.

The local reinforcers b) of the preform are advantageously provided in the form of strips made of composite material comprising a second fibrous material b1) and a polymer matrix b2). During the manufacture of the preform, and prior to the stage of injection of the resin c) for impregnation of the preform a) in the mold, the reinforcing strips are deposited on the preform or inserted into the preform, advantageously in the regions of the preform corresponding to the regions of the final composite part which are the most stressed mechanically and/or thermally.

During the deposition or the insertion of the reinforcing strips into the preform, said strips are positioned and oriented so as to optimize the mechanical and/or thermal properties of the final composite part. In particular, the strips are positioned and oriented in agreement with the future loading of the composite part.

This selective deposition or insertion of the reinforcing strips in the working regions makes it possible to use considerably reduced amounts of reinforced fibrous material b1), in particular of carbon fibers, and of reinforcing matrix b2), in order to reinforce the preform and the composite part, while providing optimum mechanical and thermal properties. Consequently, the production costs are also greatly reduced.

As regards the second fibrous material b1) of the reinforcer b), it comprises fibers which can be chosen from those which constitute the first fibrous material a1) of the prepreg. The fibers of the second fibrous material b1) of the strip and the fibers of the first fibrous material of the prepreg may or may not be of the same nature, may or may not be identical. Preferably, the fibers of the second fibrous material b1) of the strip and the fibers of the first fibrous material a1) of the prepreg are different, and those of the strip have a greater mechanical strength than that of the fibers of the first fibrous material a1) of the preform, so that they exhibit a modulus of rupture or a breaking stress greater by at least 30% than that of the fibers of the first fibrous material a1) and preferably greater by at least 100% than that of the fibers of said first fibrous material.

More preferably, the fibers of the fibrous material of the reinforcing strip are carbon fibers.

As regards the polymer matrix b2) of the reinforcer b), it comprises an acrylic or polyamide thermoplastic polymer resin, with a glass transition temperature Tg of greater than 80° C. The choice of a polymer resin having a high glass transition temperature (Tg), namely of greater than 80° C., makes it possible to enhance the mechanical and/or thermal performance qualities of the reinforcing strips and consequently of the part produced.

Preferably, the second fibrous material b1) forming the reinforcing strip b) is impregnated to the core with polymer resin b2). In this case, the second fibrous material b1) comprises an amount of polymer resin b2) of between 25% and 60% by volume, preferably between 35% and 60%, more preferably between 35% and 55% and even more preferably between 35% and 50%, by volume, with respect to the total volume of the second fibrous material b1). Reference may then be made, in this case, to “ready-for-use” preimpregnated strip, in which the resin is uniformly and homogeneously distributed around the fibers, which makes it possible to obtain a minimum of porosity and a mechanically robust reinforcing strip.

The resin constituting the polymer matrix b2) of the reinforcing strip is preferably chosen so as to make possible optimal effectiveness of said reinforcing strip throughout the operational temperature range of the final composite part, in particular when the operational temperature of said final composite part is high.

Advantageously, the resin b2) of the reinforcing strip is chosen from amorphous thermoplastic resins having a Tg of greater than 80° C., preferably of greater than 180° C. and more preferably of greater than 230° C. Preferably, the Tg is less than 250° C.

Preferably, the resin b2) of the reinforcing strip is chosen from semicrystalline thermoplastic resins having a Tg of greater than 80° C., preferably of greater than or equal to 120° C. and more preferably of greater than or equal to 150° C., and a M.p. of greater than or equal to 180° C., preferably of greater than or equal to 200° C. and more preferably of greater than or equal to 230° C. and less than 420° C., preferably less than 390° C. and more preferably less than 300° C.

Furthermore, the resin constituting the polymer matrix b2) of the reinforcing strip b) is preferably chosen so as to make possible the passage through cataphoresis of the composite part, whatever the cycle temperatures used in cataphoresis, this being the case for any type of resin for impregnation of the preform, in particular for amorphous or thermosetting impregnation resins having a glass transition temperature (Tg) which is lower than the maximum temperature of implementation of the cataphoresis or for semicrystalline impregnation resins, the melting point (M.p.) of which is lower than the maximum temperature of implementation of the cataphoresis, and thus not being compatible with the cataphoresis, or for which the passage through cataphoresis of a composite part impregnated with this resin results in reduced mechanical properties or in a deformation of said part.

The thermoplastic resin b2) of the reinforcing strip is capable of passing through cataphoresis. It can be chosen from:
amorphous thermoplastic resins exhibiting a Tg of greater than or equal to the maximum temperature of the cataphoresis cycle (which is generally of the order of 220° C.),
semicrystalline thermoplastic resins exhibiting a melting point (M.p.) of greater than or equal to the maximum temperature of the cycle of the cataphoresis.

The resin b2) of the reinforcing strip is advantageously chosen from the following resins: polyamides (PA), in particular aromatic or semiaromatic polyamides which are semicrystalline or amorphous, more particularly high temperature semicrystalline polyamides, subsequently denoted HTPA, or from acrylic thermoplastic resins, such as poly(methyl methacrylate) (PMMA) or methyl methacrylate (MMA) copolymers, or their blends.

More preferably, the resin b2) of the reinforcing strip is a high temperature polyamide HTPA. The polyamide HTPA is preferably chosen from a polyamide x.T or a copolyamide x.T/x′.T, in which T is terephthalic acid and x is a linear C₉ to C₁₈, preferably C₉ to C₁₂, aliphatic diamine and x′ is a different diamine from x, so that the molar ratio [x/(x+x′)] is between 15% and 45%, limits included. The diamine x′ is chosen from a diamine monobranched by a methyl or an ethyl and having a difference in chain length of at least one carbon atom from the diamine x, or from xylylenediamine or a linear C₄ to C₁₈ aliphatic diamine in the case where x is C₁₀ to C₁₈, or x′ C₉ to C₁₈ in the case where x is C₉ or C₁₀.

According to yet another choice, the thermoplastic polymer resin is a semiaromatic polyamide (based on an aromatic structure) and/or semicycloaliphatic polyamide (based on a cycloaliphatic structure), preferably a semiaromatic polyamide (based on an aromatic structure), homopolyamide (homopolymer) or copolyamide (polyamide copolymer), more particularly corresponding to one of the following formulae:
polyamides from: 8.T, 9.T, 10.T, 11.T, 12.T, 13.T, 14.T, 15.T, 16.T, 17.T, 18.T, 6.T/9.T, 9.T/10.T, 9.T/11.T, 9.T/12.T, 9/6.T, 10/6.T, 11/6.T, 12/6.T, 10/9.T, 10/10.T, 10/11.T, 10/12.T, 11/9.T, 11/10.T, 11/11.T, 11/12.T, 12/9.T, 12/10.T, 12/11.T, 12/12.T, 6.10/6.T, 6.12/6.T, 9.10/6.T, 9.12/6.T, 10.10/6.T, 10.12/6.T, 6.10/9.T, 6.12/9.T, 9.10/9.T, 9.12/9.T, 10.10/9.T, 10.12/9.T, 6.10/10.T, 6.12/10.T, 9.10/10.T, 9.12/10.T, 10.10/10.T, 10.12/10.T, 6.10/12.T, 6.12/12.T, 9.10/12.T, 9.12/12.T, 10.10/12.T, 11/6.T/9.T, 11/6.T/10.T, 11/6.T/11.T, 11/6.T/12.T, 11/9.T/10.T, 11/9.T/11.T, 11/9.T/12.T, 11/10.T/11.T, 11/10.T/12.T, 11/11.T/12.T, 6.T/10.T, 6.T/11.T, 6.T/12.T, 10.T/11.T, 10.T/12.T, 11.T/12.T, 12/6.T/10.T, 12/6.T/11.T, 12/6.T/12.T, 12/9.T/10.T, 12/9.T/11.T, 12/9.T/12.T, 12/10.T/11.T, 12/10.T/12.T, 12/11.T/12.T, 66/6.T, 6/6.T,
preceding polyamide terpolymers with 12/ replaced with 9/, 10/, 6.10/, 6.12/, 10.10/, 10.12/, 9.10/ and 9.12/,
all the abovementioned polyamides where terephthalic (T) is partially or completely replaced with isophthalic (I), naphthalene-2,6-dicarboxylic and/or 1,3- or 1,4-CHDA (cyclohexanedicarboxylic acid), with it being possible for all or part of the aliphatic diamines to be replaced with cycloaliphatic diamines,
all the abovementioned polyamides, with replacement of the C₆ to C₁₂ aliphatic diamine with a cycloaliphatic diamine from BMACM, BACM and/or IPDA and with replacement of all or part of the aromatic diacid T with a linear or branched C₆ to C₁₈ aliphatic diacid,
polyamides, including random or sequential copolyamides, comprising different amide units A and B and optionally different amide units C and D, the sum of the molar contents A+B+C+D or A+B or A+B+C or A+B+D, according to whether C and/or D are or are not present, being equal to 100%. The units A, B, C and D are selected as follows:
   A is a predominant amide unit present at a molar content ranging from 55% to 95%, preferably from 55% to 80%, more preferably from 55% to 75%, chosen from x.T units, where x is a linear C₉ to C₁₈, preferably C₉, C₁₀, C₁₁ or C₁₂, aliphatic diamine and where T is terephthalic acid,
   B is an amide unit different from A, which unit B is present at a molar content ranging from 5% to 45%, preferably from 20% to 45%, more preferably from 25% to 45%, depending on the M.p. of the polyamide based on unit A, and with said amide unit B being chosen from x′.T units, where x′ is chosen from:
      B1) a branched aliphatic diamine carrying a single methyl or ethyl, preferably methyl, branch (branching meaning the same thing), in particular 2-methylpentamethylenediamine (MPMD) or 2-methyloctamethylenediamine (MOMD), and having a main chain length different by at least two carbon atoms with respect to the main chain length of the diamine x of said associated unit, preferably x′ (according to B1)) being MPMD, or
      B2) m-xylylenediamine (MXD) or
      B3) a linear C₄ to C₁₈ aliphatic diamine when, in said unit A, said diamine x is a linear C₁₁ to C₁₈ aliphatic diamine and x′ is a C₉ to C₁₈ diamine when, in said unit A, said diamine x is a C₉ or C₁₀ diamine, preferably with a difference of at least two carbon atoms between the chain of diamine x of said unit A and the chain of diamine x′ of said unit B,
         and preferably said unit B is chosen from x′.T units, where x′ is MPMD according to option B1) or MXD according to option B2) or a linear aliphatic diamine as defined above according to option B3) or more preferably x′ is MPMD according to B1) or MXD according to B2) and more preferably still x′ is MXD according to B2),
C is an optional amide unit different from A and from B and chosen from amide units based on (meaning comprising) a cycloaliphatic and/or aromatic structure or based on x′.T as defined above for B but with x′ different from x′ for the unit B. Thus, if x′ of the unit C is defined according to B1), then, in this case, the unit B can have x′ defined according to either B2 or B3. If C is based on x′ according to B2, then, in this case, the unit B can have x′ defined according to either B1 or B3. Finally, if C is based on x′ according to B3, then, in this case, the unit B can have x′ defined according to either B1 or B2. More particularly, in this unit C, said aromatic structure can be chosen from the isophthalic and/or naphthalenic structure. A terephthalic structure is possible in particular for the diacid component when the diamine is cycloaliphatic. The cycloaliphatic structure can be chosen from a structure based on a cyclohexane ring or a structure based on a decahydronaphthalenic ring (hydrogenated naphthalenic structure).
D is an optional amide unit different from A, from B and from C when C is present and chosen from the aliphatic amide units resulting from:
   C₆ to C₁₂, preferably C₆, C₁₁ and C₁₂, amino acids or lactams or their mixtures,
   the reaction of a linear C₆ to C₁₈, preferably C₆ to C₁₂, aliphatic diacid and of a linear C₆ to C₁₈, preferably C₆ to C₁₂, aliphatic diamine or their mixtures, and preferably with the units A and B being respectively based on diamines x and x′ as defined above.

Optionally, it is possible to add a binder or adhesive to the reinforcing strip, in order to render compatible or to increase the compatibility between the second resin b2) of the reinforcing strip b) and the first impregnation resin c) of the preform a) used in order to obtain the final composite part. The binder can be added during the manufacture of the reinforcing strip b) or after its deposition or its insertion into the preform, using an appropriate deposition means.

The reinforcing strip can be obtained by techniques commonly used in the polymer industry. One of these methods consists in assembling rovings consisting of yarns or filaments of the desired fibers, for example carbon yarns, in order to form webs. These webs often have a width of the order of 500 mm.

The webs are subsequently impregnated with resin constituting a polymer matrix b2), in order to form the prepreg. The webs are subsequently split in order to obtain strips of low width, that is to say a width generally of the order of 5 to 100 mm. These strips can also be manufactured directly at the valid width.

### The Preparation of the Preform a)

The preform comprises several layers of prepreg provided with reinforcing strips, the arrangement of which contributes to the optimization of the mechanical properties of the final composite part. The preform can be obtained, for example, by one of the following methods:

a first method consists in combining several layers of woven fabrics of fibers or layers of nonwoven fibers (NCF, “Non Crimp Fabrics”) or layers of mats of fibers (corresponding to the first fibrous material a1)), said fibers being either dry or weakly preimpregnated with the resin a2). These layers preferably have a high width, generally of the order of 1 m, and are deposited on a metal support, the shape of which corresponds substantially to that of the final composite part. The layers are preimpregnated with the polymer resin a2), optionally different from the resin b2) and from the resin c) for impregnation of the preform, or binder, making it possible to connect together the different layers of woven fabrics or of fibers. The preform is stiffened by heating the layers of woven fabrics or of fibers. The reinforcing strips b1) according to the invention are subsequently deposited at the surface of the preform in predefined regions requiring a local reinforcer.
a second method consists in manufacturing the preform from unidirectional strips (corresponding to the first fibrous material a1)), weakly preimpregnated with the resin a2), optionally different from the resin b2) and from the resin c) for impregnation of the preform. The preimpregnated unidirectional strips are deposited by means of a robot according to the AFP (Automatic Fiber Placement) process. Contrary to the preceding method, the local reinforcing strips b) according to the invention, which are completely preimpregnated, are in this instance added by the robot during the preparation of the preform, at the same time as the unidirectional strips. This makes it possible have greater freedom with regard to the positioning of the strips, which can in particular be inserted at the core of the preform, as deposited at the surface. Preferably, the local reinforcers are deposited at the core of the preform.

### The Impregnation Polymer Resin c)

Polymer resin is understood in this instance to mean a weakly viscous chemical composition, that is to say a chemical composition exhibiting a viscosity of less than 100 Pa·s, comprising components comprising reactive groups. Such a resin, when it is injected into a mold containing the preform, makes it possible, by impregnation of the preform and subsequent polymerization of the resin, to obtain a part made of composite material for varied applications, for example the railroad or aeronautical field or also the building industry and the construction industry.

The resins used are reactive resins, making possible in situ polymerization. These resins are weakly viscous, with a viscosity preferably of less than or equal to 100 Pa·s, preferably of less than 20 Pa·s and more preferably still of less than 0.2 Pa·s, at the temperature of introduction of the resin into the mold.

The polymerization of the resin can be a polymerization by the radical route or a polyaddition or polycondensation.

The impregnation resin can be chosen from: thermosetting resins or thermoplastic resins.

When the resin is chosen from thermosetting resins, it is chosen from polyester thermosetting resins, vinyl ester thermosetting resins, acrylic thermosetting resins, epoxy thermosetting resins (epoxy-amine system), polyimide thermosetting resins (in particular the bismaleimide resin), polyurethane thermosetting resins or their blends.

When it is chosen from thermoplastic resins, it is chosen from polyamide (PA and HTPA) thermoplastic resins or acrylic thermoplastic resins or their blends.

The polyamide (PA and HTPA) resins used can be obtained by ring opening of lactams, in particular the lactams which have from 3 to 12 carbon atoms on the main ring and which can be substituted. Mention may be made, by way of example, of β,β-dimethylpropriolactam, α,α-dimethylpropriolactam, amylolactam, caprolactam, capryllactam and lauryllactam. The polyamide resins can in addition contain additives, such as dyes, pigments, optical brighteners, antioxidants or UV stabilizers.

The polyamide resins used can in addition be obtained by reaction of a polyamide prepolymer P(X)ₙ comprising n identical reactive functional groups X, preferably carboxy or amino functional groups, with a nonpolymeric chain extender Y-A-Y, the identical functional groups Y of which react with the functional groups X of the prepolymer.

The specific choice of the chain extenders, with respect to the functional groups X borne by said prepolymer, is defined in the following way:
when X is NH₂ or OH, preferably NH₂:
   either the chain extender Y-A-Y corresponds to
      Y chosen from the following groups: maleimide, isocyanate, optionally blocked isocyanate, oxazinone and oxazolinone, preferably oxazinone and oxazolinone, and
      A being a carbon-based spacer or a carbon-based radical carrying the reactive groups or functional groups Y, A chosen from:
         a covalent bond between two functional groups (groups) Y in the case where Y=oxazinone, oxazolinone, or
         an aliphatic hydrocarbon chain or an aromatic and/or cycloaliphatic hydrocarbon chain, the latter two comprising at least one optionally substituted ring of 5 or 6 carbon atoms, said aliphatic hydrocarbon chain preferably having a molecular weight of 14 to 200
   or the chain extender Y-A-Y has, as group Y, a caprolactam and it being possible for A to be a carbonyl, such as carbonylbiscaprolactam, or A can be a terephthaloyl or an isophthaloyl,
   or said chain extender corresponds to Y being a cyclic anhydride group, which means that said extender carries or comprises two cyclic anhydride groups Y and this extender is chosen from an aromatic and/or cycloaliphatic carboxylic dianhydride and more preferably it is chosen from: ethylenetetracarboxylic dianhydride, pyromellitic dianhydride, 3,3′,4,4′-biphenyltetracarboxylic dianhydride, 1,4,5,8-naphthalenetetracarboxylic dianhydride, perylenetetracarboxylic dianhydride, 3,3′,4,4′-benzophenone tetracarboxylic dianhydride, 1,2,3,4-cyclobutanetetracarboxylic dianhydride, hexafluoroisopropylidene bisphthalic dianhydride, 9,9-bis(trifluoromethyl)xanthenetetracarboxylic dianhydride, 3,3′,4,4′-diphenylsulfone tetracarboxylic dianhydride, bicyclo[2.2.2]oct-7-ene-2,3,5,6-tetracarboxylic dianhydride, 1,2,3,4-cyclopentanetetracarboxylic dianhydride, 3,3′,4,4′-diphenyl ether tetracarboxylic dianhydride or their mixtures,
and, when X is COOH:
   the chain extender Y-A-Y corresponds to:
      Y chosen from the following groups: oxazoline, oxazine, imidazoline and aziridine, such as 1,1′-isophthaloylbis(2-methylaziridine) or the equivalent aziridine with terephthaloyl, and to
      A being a carbon-based spacer (radical) as defined above, with A, in the case of the oxazolines, oxazines and imidazolines, being able to be a single covalent bond between the two groups.

More particularly, when Y is chosen from oxazinone, oxazolinone, oxazine, oxazoline or imidazoline, in this case, in the chain extender represented by Y-A-Y, A can represent an alkylene, such as —(CH₂)ₘ— with m ranging from 1 to 14 and preferably from 2 to 10, or A can also represent a cycloalkylene and/or an arylene which is substituted (alkyl) or unsubstituted, such as benzenic arylenes, for example o-, m- or p-phenylenes, or naphthalenic arylenes, and preferably A is an arylene and/or a cycloalkylene.

In the case of carbonyl- or terephthaloyl- or isophthaloylbiscaprolactam as chain extender Y-A-Y, the preferred conditions avoid the elimination of byproduct, such as caprolactam, during the polymerization and processing in the molten state.

In the optional case mentioned above where Y represents a blocked isocyanate functional group, this blocking can be obtained by blocking agents for the isocyanate functional group, such as epsilon-caprolactam, methyl ethyl ketoxime, dimethylpyrazole or diethyl malonate.

For X=OH or NH₂, the group Y is preferably chosen from: isocyanate (nonblocked), oxazinone and oxazolinone, more preferably oxazinone and oxazolinone, with, as spacer (radical), A which is as defined above.

Reference may be made, as examples of chain extenders with oxazoline or oxazine reactive functional groups Y which are suitable for the implementation of the process according to the invention, to those described under references A, B, C and D on page 7 of the application EP 0 581 642 of the applicant company, and also to their processes of preparation and their modes of reaction which are disclosed therein. A is bisoxazoline, B is bisoxazine, C is 1,3-phenylenebisoxazoline and D is 1,4-phenylenebisoxazoline.

Reference may be made, as examples of chain extenders having an imidazoline reactive functional group Y which are suitable for the implementation of the process according to the invention, to those described (A to F) on pages 7 to 8 and table 1 on page 10 in the application EP 0 739 924 of the applicant company, and also to their processes of preparation and their modes of reaction which are disclosed therein.

Reference may be made, as examples of chain extenders having a reactive functional group Y=oxazinone or oxazolinone which are suitable for the implementation of the process according to the invention, to those described under references A to D on pages 7 to 8 of the application EP 0 581 641 of the applicant company, and also to their processes of preparation and their modes of reaction which are disclosed therein.

Mention may be made, as examples of oxazinone (ring having 6 atoms) and oxazolinone (ring having 5 atoms) groups Y which are suitable, of the groups Y derived from: benzoxazinone, oxazinone or oxazolinone, with as spacer A which can be a single covalent bond with for respective corresponding extenders being: bis(benzoxazinone), bisoxazinone and bisoxazolinone.

A can also be a C₁ to C₁₄, preferably C₂ to C₁₀, alkylene but A is preferably an arylene and more particularly it can be a phenylene (1,2- or 1,3- or 1,4- substituted by Y) or a naphthalene radical (disubstituted by Y) or a phthaloyl (iso- or terephthaloyl) or A can be a cycloalkylene.

For the functional groups Y, such as oxazine (6-membered ring), oxazoline (5-membered ring) and imidazoline (5-membered ring), the radical A can be as described above with it being possible for A to be a single covalent bond and with the respective corresponding extenders being: bisoxazine, bisoxazoline and bisimidazoline. A can also be a C₁ to C₁₄, preferably C₂ to C₁₀, alkylene. The radical A is preferably an arylene and it can more particularly be a phenylene (1,2- or 1,3- or 1,4- substituted by Y) or a naphthalene radical (disubstituted by Y) or a phthaloyl (iso- or terephthaloyl) or A can be a cycloalkylene.

In the case where Y=aziridine (3-membered nitrogenous heterocycle equivalent to ethylene oxide with replacement of the ether —O— by —NH—), the radical A can be a phthaloyl (1,1′-iso- or terephthaloyl) with, as example of extender, 1,1′-isophthaloylbis(2-methylaziridine).

The polyamide resins used can also be obtained by reaction of two prepolymers having complementary reactive functional groups.

According to yet another choice, the thermoplastic polymer resin is a semiaromatic polyamide (based on an aromatic structure) and/or semicycloaliphatic polyamide (based on a cycloaliphatic structure), preferably a semiaromatic polyamide (based on an aromatic structure), homopolyamide (homopolymer) or copolyamide (polyamide copolymer), more particularly corresponding to one of the following formulae:
polyamides from: 8.T, 9.T, 10.T, 11.T, 12.T, 13.T, 14.T, 15.T, 16.T, 17.T, 18.T, 6.T/9.T, 9.T/10.T, 9.T/11.T, 9.T/12.T, 9/6.T, 10/6.T, 11/6.T, 12/6.T, 10/9.T, 10/10.T, 10/11.T, 10/12.T, 11/9.T, 11/10.T, 11/11.T, 11/12.T, 12/9.T, 12/10.T, 12/11.T, 12/12.T, 6.10/6.T, 6.12/6.T, 9.10/6.T, 9.12/6.T, 10.10/6.T, 10.12/6.T, 6.10/9.T, 6.12/9.T, 9.10/9.T, 9.12/9.T, 10.10/9.T, 10.12/9.T, 6.10/10.T, 6.12/10.T, 9.10/10.T, 9.12/10.T, 10.10/10.T, 10.12/10.T, 6.10/12.T, 6.12/12.T, 9.10/12.T, 9.12/12.T, 10.10/12.T, 11/6.T/9.T, 11/6.T/10.T, 11/6.T/11.T, 11/6.T/12.T, 11/9.T/10.T, 11/9.T/11.T, 11/9.T/12.T, 11/10.T/11.T, 11/10.T/12.T, 11/11.T/12.T, 6.T/10.T, 6.T/11.T, 6.T/12.T, 10.T/11.T, 10.T/12.T, 11.T/12.T, 12/6.T/10.T, 12/6.T/11.T, 12/6.T/12.T, 12/9.T/10.T, 12/9.T/11.T, 12/9.T/12.T, 12/10.T/11.T, 12/10.T/12.T, 12/11.T/12.T, 66/6.T, 6/6.T,
preceding polyamide terpolymers with 12/ replaced with 9/, 10/, 6.10/, 6.12/, 10.10/, 10.12/, 9.10/ and 9.12/,
all the abovementioned polyamides where terephthalic (T) is partially or completely replaced with isophthalic (I), naphthalene-2,6-dicarboxylic and/or 1,3- or 1,4-CHDA (cyclohexanedicarboxylic acid), with it being possible for all or part of the aliphatic diamines to be replaced with cycloaliphatic diamines,
all the abovementioned polyamides, with replacement of the C₆ to ^{C}₁₂ aliphatic diamine with a cycloaliphatic diamine from BMACM, BACM and/or IPDA and with replacement of all or part of the aromatic diacid T with a linear or branched C₆ to C₁₈ aliphatic diacid,
polyamides, including random or sequential copolyamides, comprising different amide units A and B and optionally different amide units C and D, the sum of the molar contents A+B+C+D or A+B or A+B+C or A+B+D, according to whether C and/or D are or are not present, being equal to 100%. The units A, B, C and D are selected as follows:
   A is a predominant amide unit present at a molar content ranging from 55% to 95%, preferably from 55% to 80%, more preferably from 55% to 75%, chosen from x.T units, where x is a linear C₉ to C₁₈, preferably C₉, C₁₀, C₁₁ or C₁₂, aliphatic diamine and where T is terephthalic acid,
   B is an amide unit different from A, which unit B is present at a molar content ranging from 5% to 45%, preferably from 20% to 45%, more preferably from 25% to 45%, depending on the M.p. of the polyamide based on unit A, and with said amide unit B being chosen from x′.T units, where x′ is chosen from:
      B1) a branched aliphatic diamine carrying a single methyl or ethyl, preferably methyl, branch (branching meaning the same thing), in particular 2-methylpentamethylenediamine (MPMD) or 2-methyloctamethylenediamine (MOMD), and having a main chain length different by at least two carbon atoms with respect to the main chain length of the diamine x of said associated unit, preferably x′ (according to B1)) being MPMD, or
      B2) m-xylylenediamine (MXD) or
      B3) a linear C₄ to C₁₈ aliphatic diamine when, in said unit A, said diamine x is a linear C₁₁ to C₁₈ aliphatic diamine and x′ is a C₉ to C₁₈ diamine when, in said unit A, said diamine x is a C₉ or C₁₀ diamine, preferably with a difference of at least two carbon atoms between the chain of diamine x of said unit A and the chain of diamine x′ of said unit B,
         and preferably said unit B is chosen from x′.T units, where x′ is MPMD according to option B1) or MXD according to option B2) or a linear aliphatic diamine as defined above according to option B3) or more preferably x′ is MPMD according to B1) or MXD according to B2) and more preferably still x′ is MXD according to B2),
C is an optional amide unit different from A and from B and chosen from amide units based on (meaning comprising) a cycloaliphatic and/or aromatic structure or based on x′.T as defined above for B but with x′ different from x′ for the unit B. Thus, if x′ of the unit C is defined according to B1), then, in this case, the unit B can have x′ defined according to either B2 or B3. If C is based on x′ according to B2, then, in this case, the unit B can have x′ defined according to either B1 or B3. Finally, if C is based on x′ according to B3, then, in this case, the unit B can have x′ defined according to either B1 or B2. More particularly, in this unit C, said aromatic structure can be chosen from the isophthalic and/or naphthalenic structure. A terephthalic structure is possible in particular for the diacid component when the diamine is cycloaliphatic. The cycloaliphatic structure can be chosen from a structure based on a cyclohexane ring or a structure based on a decahydronaphthalenic ring (hydrogenated naphthalenic structure).
D is an optional amide unit different from A, from B and from C when C is present and chosen from the aliphatic amide units resulting from:
   C₆ to C₁₂, preferably C₆, C₁₁ and C₁₂, amino acids or lactams or their mixtures,
   the reaction of a linear C₆ to C₁₈, preferably C₆ to C₁₂, aliphatic diacid and of a linear C₆ to C₁₈, preferably C₆ to C₁₂, aliphatic diamine or their mixtures, and preferably with the units A and B being respectively based on diamines x and x′ as defined above.

The impregnation resin c) can be chosen from the constituent resins of the polymer matrix a2) of the first fibrous material a1) of the prepreg or from the constituent resins of the polymer matrix b2) of the second fibrous material b1) of the reinforcer b). Preferably, it is chosen from the constituent resins of the polymer matrix b2) of the second fibrous material b1) of the reinforcer b).

The impregnation resin c) can be of the same chemical nature as or of a different chemical nature from the polymer matrix a2) of the first fibrous material a1) of the prepreg of the preform. Preferably, the impregnation resin is of the same chemical nature as the polymer matrix a2) of the first fibrous material a1) of the prepreg of the preform.

The impregnation resin c) can be of the same chemical nature as or of a different chemical nature from the polymer matrix b2) of the second fibrous material b1) of the reinforcer b). Preferably, the impregnation resin is of a different chemical nature from the polymer matrix b2) of the second fibrous material b1) of the reinforcer b).

Preferably, the impregnation resin c) is chosen from the resins which are incapable of passing through cataphoresis, so as to make possible an impregnation of the preform at a lower temperature. Among these resins, the choice will preferably be made of amorphous thermosetting or thermoplastic resins, the Tg of which is <230° C. and preferably ≤150° C., and more particularly less than or equal to 120° C., and more preferably still less than or equal to 100° C., or of semicrystalline thermoplastic resins, the M.p. of which is <230° C., preferably less than or equal to 200° C., and more preferably still less than or equal to 190° C.

The impregnation resin c) and the resin constituting the polymer matrix b2) of the second fibrous material b1) of the reinforcer b) are preferably chosen so as to be compatible with one another. The choice can also be made of an impregnation resin c) compatible with the resin a2) impregnating the first fibrous material a1) of the preform. “Compatible” is understood to mean that the impregnation resin is capable of adhering to the resin of the reinforcing strip. In particular, the two resins have a good chemical affinity for one another.

The Manufacture of the Composite Parts from the Preform

The parts made of composite material can be obtained according to different processes carried out subsequent to the production of the preform, by injection of the impregnation resin into a mold containing said preform. The term “injection” should be understood in this instance in the broad sense and brings together different manufacturing techniques, among which may be mentioned vacuum bag molding, pressure bag molding, autoclave molding, resin transfer molding (RTM) and its alternative forms, such as compression resin transfer molding (C-RTM) and vacuum assisted resin transfer molding (VARTM), reaction injection molding (RIM), reinforced reaction injection molding (R-RIM) and its alternative forms, press molding, pultrusion molding, hot stamping molding, filament winding molding, infusion molding, molding in a bag under vacuum or under pressure, or also by compression by the wet route (LCM or WCM or DFCM).

Preferably, the manufacturing process according to the invention is carried out by resin transfer molding (RTM), compression resin transfer molding (C-RTM), or by infusion or by compression by the wet route (LCM or WCM or DFCM).

Resin transfer molding is a process using a two-sided mold set which forms both surfaces of a composite material. The lower side is a rigid mold. The upper side can be a rigid or flexible mold. Flexible molds can be manufactured from composite materials, from silicone or from extruded polymer films, such as nylon. The two sides fit together to form a mold cavity. The distinctive characteristic of resin transfer molding is that the fibrous substrate, which in the context of the present invention is a preform, is placed in this cavity and that the mold set is closed before the introduction of the impregnation resin. Resin transfer molding comprises numerous variations which differ in the mechanism of introduction of the resin at the fibrous substrate in the mold cavity. These variations range from vacuum infusion to vacuum assisted resin transfer molding (VARTM). By virtue of the vacuum, the fibrous substrate is infused and better impregnated by the resin. One advantage of this process is the large amount of fibrous material in the final composite material obtained. This process can be carried out at ambient temperature or elevated temperature. There also exists a C-RTM version.

In the case of the infusion, the resin is sucked into the fibrous substrate, present in a special large-sized mold, by application of a slight vacuum. The fibrous substrate is infused and completely impregnated with the resin. One advantage of this process is the large size of the composite part manufactured.

In the case of molding by the wet route, the deposition of the resin is carried out either outside the mold, on a flat preform, or in the open mold containing the preform.

The manufacturing process according to the invention employs a reinforcing strip, the constituent resin of the polymer matrix b2) of which has a high Tg, greater than the operational temperature of the final composite part. Consequently, it is possible to use an impregnation resin c), the Tg of which is low and which, without addition of reinforcing strip according to the invention, would not be suitable or very suitable for use of the part within high temperature ranges. Thus, the range of impregnation resins which can be used for the production of parts made of composite material, obtained in particular by processes of RTM or LCM type or their alternative forms, is widened.

Furthermore, the use of reinforcing strip, the constituent resin of the polymer matrix of which has a very high Tg, typically an amorphous polymer with a Tg greater than the maximum temperature of the cataphoresis cycle, or the constituent resin of the polymer matrix of which has a high M.p., typically a semicrystalline polymer with a M.p. greater than the maximum temperature of the cataphoresis cycle, makes possible the passage of the final composite part through cataphoresis, even when the impregnation resin is not initially capable of undergoing a cataphoresis. Thus, the range of impregnation resins which can be used for the production of parts made of composite material which are intended to pass through cataphoresis is widened.

According to the fibers and the polymer matrix of the reinforcing strip used in the context of the process for the manufacture of composite part according to the invention, it is possible to obtain composite parts which can be used within high operational temperature ranges, even with an impregnation resin c) of low Tg, or composite parts capable of passing through cataphoresis even with an impregnation resin c) of low Tg or low M.p., according to whether it is an amorphous thermoplastic, thermosetting or semicrystalline thermoplastic resin, or composite parts having jointly the two preceding characteristics.

As described above, the composite parts comprise a preform comprising a prepreg, formed of a first fibrous material a1) and of a polymer matrix a2), and local reinforcers b), which are provided in the form of strips formed of a second fibrous material b1) and of a polymer matrix b2).

According to a preferred embodiment of the invention, the prepreg and the reinforcing strip constituting the preform, and also the impregnation resin c), are chosen so as to manufacture a final composite part comprising:
at least one prepreg a1) comprising glass fibers and a polymer matrix a2),
at least one reinforcing strip b) comprising carbon fibers and a polymer matrix b2) comprising high temperature semicrystalline polyamide (HTPA) or else acrylic thermoplastic resins, such as poly(methyl methacrylate) (PMMA) or methyl methacrylate (MMA) copolymers,
a resin for impregnation c) of the preform, with a low viscosity, of less than 100 Pa·s, and consisting of an epoxy resin or of a polyamide (PA, HTPA) resin or of an acrylic resin.

The composite parts obtained by the manufacturing process according to the invention have a reduced manufacturing cost and have optimal mechanical and/or thermal properties for the desired applications, including: mechanical engineering, the aeronautical (window glazing, jet engine tail cone) and nautical (sailboat hull) fields, the motor vehicle industry (chassis, hood, door, vent), the energy sector, the building industry, the construction industry, the health and medical fields, the army and the armaments industry, sports and leisure (bicycle frame and fork), and the electronics industry.

1. A process for the manufacture of a part made of composite material, wherein said part is obtained from a preform comprising local reinforcers and a first impregnation resin of low viscosity, of less than 100 Pa·s, for said preform and in that said process comprises the following stages:
i) production of said preform comprising a first fibrous material and said local reinforcers, which are provided in the form of reinforcers formed of a second fibrous material having fibers with a greater mechanical strength than that of the fibers of the first fibrous material, so that they exhibit a modulus of rupture or a breaking stress greater by at least 30% than that of the fibers of said first fibrous material, said second fibrous material being preimpregnated with a second, acrylic or polyamide, thermoplastic polymer resin having a glass transition temperature (Tg) of greater than 80° C., the amount of second polymer resin being between 25% and 60% by volume, with respect to the total volume of said second fibrous material,
ii) impregnation of said preform with the first impregnation resin,
iii) cooling of said impregnated preform in order to obtain the part.

2. The process as claimed in claim 1, wherein the part is made:
by injection molding in a closed mold or
by deposition of the resin on the preform either outside the mold or in the open mold containing the preform.

3. The process as claimed in claim 1, wherein the local reinforcers are provided either in the form of felts or of mats, or in the form of woven fabrics, of nonwoven fabrics, of unidirectional fibers or of braids.

4. The process as claimed in claim 1, wherein stage i) of production of said preform comprises the deposition of said local reinforcers at the surface of said preform and/or the insertion of said local reinforcers into the preform:
by stacking layers of woven fabrics of fibers or layers of nonwoven fibers or layers of mats of fibers, said fibers being either dry or weakly preimpregnated with a third resin, optionally different from the first and the second resin, and by then depositing at the surface the reinforcers formed of the second fibrous material in order to produce said local reinforcers, or
by manufacturing the preform from unidirectional strips weakly preimpregnated with a third resin optionally different from the first and the second resin, which are deposited by means of a robot, and by adding, in the same operation and preferably at the core of the preform, the reinforcers formed of the second completely preimpregnated fibrous material which constitute said local reinforcers.

5. The process as claimed in claim 1, wherein stage i) of production of the preform is carried out by an automatic fiber placement (AFP) process in which said reinforcers are deposited at the surface of the preform and/or inserted into the preform during its manufacture, by a servo robot.

6. The process as claimed in claim 3, wherein the reinforcing fibers constituting the webs, woven fabrics, NCFs, mats of fibers or unidirectional strips are comixed with one or more polymer fibers.

7. The process as claimed in claim 6, wherein the polymer or polymers constituting the fibers comixed with the reinforcing fibers are ductile within the operational temperature range of the composite.

8. The process as claimed in claim 6, wherein the polymer or polymers constituting the fibers comixed with the reinforcing fibers comprise electrically and/or thermally conducting fillers which are preferably carbon nanotubes.

9. The process as claimed in claim 1, wherein the preform is shaped by a hot stamping process comprising a first stage of preheating the preform followed by a second stage of stamping to the final shape, by means of a heating platen press.

10. The process as claimed in claim 1, wherein it is an infusion molding process.

11. The process as claimed in claim 1, wherein it is a resin transfer molding, compression resin transfer molding or vacuum assisted resin transfer molding process.

12. The process as claimed in claim 1, wherein it is a process for compression molding by the wet route.

13. The process as claimed in claim 1, wherein the first impregnation resin is injected into a closed mold at a pressure of between 500 mbar and 200 bar.

14. The process as claimed in claim 1, wherein the first impregnation resin exhibits, at the injection temperature, in the case of a process in a closed mold, or at the molding temperature, in the case of a process in an open mold, a viscosity of less than 100 Pa·s.

15. The process as claimed in claim 1, wherein the first fibrous material is made of glass fibers.

16. The process as claimed in claim 1, wherein the first fibrous material is preimpregnated with a third polymer resin.

17. The process as claimed in claim 1, wherein the second reinforcing fibrous material is made of carbon fibers.

18. The process as claimed in claim 1, wherein the first fibrous material is made of glass fibers and the second reinforcing fibrous material is made of carbon fibers.

19. The process as claimed in claim 1, wherein the second polymer resin impregnating the second fibrous material is chosen from amorphous thermoplastic resins having a Tg of greater than or equal to 80° C.

20. The process as claimed in claim 1, wherein the second polymer resin impregnating the second fibrous material is chosen from semicrystalline thermoplastic resins exhibiting a Tg of greater than or equal to 80° C.

21. The process as claimed in claim 1, wherein the second polymer resin impregnating the second fibrous material is a thermoplastic resin chosen from: polyamides, or also acrylic thermoplastic resins, or their blends.

22. The process as claimed in claim 21, wherein the second polymer resin impregnating the second fibrous material is a semicrystalline resin selected from polyamides.

23. The process as claimed in claim 1, wherein the second fibrous material of the local reinforcer comprises an amount of second polymer resin of between 35% and 60% by volume, with respect to the total volume of said second fibrous material.

24. The process as claimed in claim 1, wherein the first impregnation resin has a Tg of less than 230° C.

25. The process as claimed in claim 1, wherein the first impregnation resin is semicrystalline and has a M.p. of less than 230° C.

26. The process as claimed in claim 1, wherein the first impregnation resin is chosen from: thermosetting resins, or polyurethane thermosetting resins, or from thermoplastic resins, or their blend.

27. The process as claimed in claim 1 wherein the first impregnation resin is chosen from epoxy resins and the second polymer resin of the reinforcer made of second fibrous material is a polyamide (PA, HTPA) resin.

28. The process as claimed in claim 1, wherein the first resin for impregnation of the preform is compatible with said second for impregnation of the second fibrous material and/or with the third resin for impregnation of the first fibrous material.

29. A part made of composite material, wherein it comprises a preform impregnated with a first impregnation resin, said preform comprising an assembly of a first fibrous material and of local reinforcers formed of a second fibrous material having fibers with a greater strength than that of the fibers of the first fibrous material, and exhibiting a modulus greater by at least 30% than that of the fibers of said first fibrous material, said second fibrous material being preimpregnated with a second, acrylic or polyamide, thermoplastic polymer resin having a glass transition temperature (Tg) of greater than 80° C., the amount of second polymer resin being between 25% and 60% by volume, with respect to the total volume of said second fibrous material, said preform being impregnated with said first impregnation resin.

30. The part as claimed in claim 29, wherein it is obtained by a process comprising the following stages:
i) production of said preform comprising a first fibrous material and said local reinforcers, which are provided in the form of reinforcers formed of a second fibrous material having fibers with a greater mechanical strength than that of the fibers of the first fibrous material, so that they exhibit a modulus of rupture or a breaking stress greater by at least 30% than that of the fibers of said first fibrous material, said second fibrous material being preimpregnated with a second, acrylic or polyamide, thermoplastic polymer resin having a glass transition temperature (Tg) of greater than 80° C., the amount of second polymer resin being between 25% and 60% by volume, with respect to the total volume of said second fibrous material,
ii) impregnation of said preform with the first impregnation resin,
iii) cooling of said impregnated preform in order to obtain the part.

31. The part as claimed in claim 29, wherein the first fibrous material is preimpregnated with a third polymer resin.

32. The part as claimed in claim 29 wherein it comprises:
at least one preform comprising a first fibrous material made of glass fibers and optionally preimpregnated with a polymer resin,
at least one reinforcer comprising a second fibrous material made of carbon fibers, said second fibrous material being preimpregnated with a thermoplastic polymer resin having a glass transition temperature (Tg) of greater than 80° C.,
a resin for impregnation of said preform, with a low viscosity, of less than 100 Pa·s, chosen from epoxy resins, polyamide (PA or HTPA) resins or acrylic resins.

33. The part as claimed in claim 29, wherein the polymer resin of the reinforcer comprising the second fibrous material is additionally chosen from acrylic thermoplastic resins.

34. The use of a part as claimed in claim 29, for applications in building engines or machines, aircraft or ships, or water sports, motor vehicle chassis, wind, tidal or hydroelectric power (wind turbine, marine turbine, turbines) or in the construction industry, or also for the health and medical fields, the army and the armaments industry, sports and leisure, the electronics industry, or solar (mirrors) or photovoltaic (panels) power plants.
